(19) United States
(12) Patent Application Publication
(10) Pub. No.: US 2009/0080658 A1
(43) Pub. Date: Mar. 26, 2009

(54) METHOD AND APPARATUS FOR ENCRYPTING DATA FOR FINE-GRAINED ACCESS CONTROL

(76) Inventors: Brent Waters, Columbia, MD (US); Amit Sahai, Los Angeles, CA (US); Vipul Goyal, Los Angeles, CA (US); Omkant Pandey, Los Angeles, CA (US)

Correspondence Address: PATTERSON & SHERIDAN, LLP;SRI INTERNATIONAL, 595 SHREWSBURY AVENUE, SUITE 100, SHREWSBURY, NJ, 07702, US

(21) Appl. No.: 12/172,835

(22) Filed: Jul. 14, 2008

Related U.S. Application Data
(60) Provisional application No. 60/949,807, filed on Jul. 13, 2007.
(60) Provisional application No. 60/971,181, filed on Sep. 10, 2007.

(51) Int. Cl. H04L 9/06; G06F 21/00

(52) U.S. Cl. 380/277; 726/27

(57) ABSTRACT

In one embodiment, the present invention is a method and apparatus for encrypting data for fine-grained access control. One embodiment of a method for encrypting data includes encrypting the data as a ciphertext, labeling the ciphertext with a set of one or more descriptive attributes, generating a decryption key for decrypting the ciphertext, associating an access structure with the decryption key, such that the data is recoverable from the ciphertext using the decryption key only if the set of one or more descriptive attributes satisfies the access structure, and outputting the ciphertext and the decryption key.

### CROSS REFERENCE TO RELATED APPLICATIONS

This application claims the benefit of U.S. Provisional Patent Application No. 60/949,807, filed Jul. 13, 2007; and U.S. Provisional Patent Application No. 60/971,181, filed Sep. 10, 2007, both of which are herein incorporated by reference in their entireties.

### REFERENCE TO GOVERNMENT FUNDING

This invention was made with Government support under grant number W911NF-06-1-0316 awarded by the U.S. Army Research Office; contract number NBCHF040146 awarded by the Department of the Interior; and grant numbers 0456717, 0627781, 0205594, and CNS-0524111 awarded by the National Science Foundation. The Government has certain rights in this invention.

### FIELD OF THE INVENTION

The present invention generally relates to data security, and more particularly relates to attribute-based data encryption.

### BACKGROUND OF THE DISCLOSURE

Sensitive user data is often stored by third parties on the Internet. For example, personal email, data, and personal preferences may be stored on web portal sites. Given the variety, amount, and importance of information stored at such sites, there is cause for concern that personal data will be compromised. This worry is escalated by the surge in recent attacks and legal pressure faced by such sites.

One method for alleviating some of these problems is to store data in encrypted form. Thus, if the storage is compromised, the amount of information loss will be limited. One disadvantage of encrypting data, however, is that it limits the ability of users to selectively share their encrypted data at a fine-grained level. For instance, if a first user wanted to grant decryption access to a second user to all of his or her Internet traffic logs for all entries on a particular range of dates that had a source IP address from a particular subnet, the first user would need to either act as an intermediary and decrypt all relevant entries for the second user or give the user his or her private decryption key, thereby allowing the second user access to all entries. Neither one of these options is particularly appealing.

Thus, there is a need in the art for a method and apparatus for encrypting data for fine-grained access control.

### SUMMARY OF THE INVENTION

In one embodiment, the present invention is a method and apparatus for encrypting data for fine-grained access control. One embodiment of a method for encrypting data includes encrypting the data as a ciphertext, labeling the ciphertext with a set of one or more descriptive attributes, generating a decryption key for decrypting the ciphertext, associating an access structure with the decryption key, such that the data is recoverable from the ciphertext using the decryption key only if the set of one or more descriptive attributes satisfies the access structure, and outputting the ciphertext and the decryption key.

### BRIEF DESCRIPTION OF THE DRAWINGS

The teachings of the present invention can be readily understood by considering the following detailed description in conjunction with the accompanying drawings, in which:

FIG. 1 is a flow diagram illustrating one embodiment of a method for encrypting data, according to the present invention;

FIG. 2 illustrates on embodiment of a method for decrypting data, according to the present invention;

FIG. 3 is a flow diagram illustrating a second embodiment of a method for encrypting data, according to the present invention;

FIG. 4 is a flow diagram illustrating a method for decrypting data, according to the present invention;

FIG. 5 is a flow illustrating a third embodiment of a method for encrypting data, according to the present invention;

FIG. 6 is a flow diagram illustrating a method for decrypting data, according to the present invention;

FIG. 7 is a flow diagram illustrating a fourth embodiment of a method for encrypting data, according to the present invention;

FIG. 8 is a flow diagram illustrating one embodiment of a method for decrypting data, according to the present invention;

FIG. 9 is a flow diagram illustrating one embodiment of a method for computing a new private key from an existing private key;

FIG. 10 is a flow diagram illustrating one embodiment of a method for encrypting data according to the present invention;

FIG. 11 is a flow diagram illustrating one embodiment of a method for decrypting data, according to the present invention; and

FIG. 12 is a high level block diagram of the encryption/decryption method that is implemented using a general purpose computing device.

To facilitate understanding, identical reference numerals have been used, where possible, to designate identical elements that are common to the figures.

### DETAILED DESCRIPTION

In one embodiment, the present invention is a method and apparatus for encrypting data for fine-grained access control. Embodiments of the invention develop an attribute-based encryption cryptosystem for use in connection with a variety of applications. In embodiments of the invention, each ciphertext is labeled by an encryptor with a set of descriptive attributes. Each private key is associated with an access structure that specifies which type of ciphertexts the private key can decrypt. More specifically, embodiments of the invention associate each user's private key with a tree access structure, where leaves of the tree are associated with attributes of ciphertexts. A user is able to decrypt a ciphertext if the attributes associated with the ciphertext satisfy the private key's tree access structure.

Further embodiments of the invention provide a delegation mechanism that allows any user that has a private key for tree access structure X to derive a private key for tree access structure Y, if and only if Y is more restrictive than X.

Within the context of the present invention, “access structure” is understood to refer to the following: Let {P₁, P₂, . . . , Pₙ} be a set of parties. A collection A⊂2^{{P}^{₁}^{,P}^{₂}^{, . . . P}^{ₙ}^{}} is monotone if ∀B,C: if BεA and B⊂ C then Cε A. An access structure (respectively, monotone access structure) is a collection (respectively, monotone collection) A of non-empty subsets of {P₁, P₂, . . . , Pₙ}, i.e., A ⊂2^{{P}^{₁}^{,P}^{₂}^{, . . . P}^{ₙ}^{}}\{Ø}. The sets in A are called the authorized sets, and the sets not in A are called the unauthorized sets.

Within the context of the present invention, the role of the parties in the above definition is taken by the attributes associated with the ciphertexts. Thus, the access structure A will contain the authorized sets of attributes. Although attention is directed herein to monotone access structures, those of skill in the art will appreciate that it is also possible to realize general access structures using the techniques disclosed by having the “not” of an attribute as a separate attribute, thereby doubling the number of attributes in a system so implemented. Unless stated otherwise, an “access structure” as used herein is understood to refer to a monotone access structure.

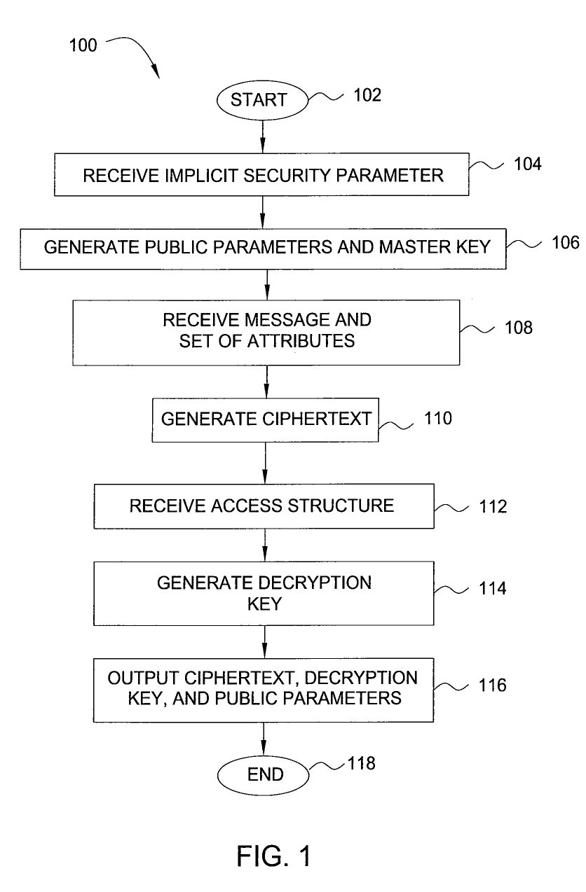

FIG. 1 is a flow diagram illustrating one embodiment of a method 100 for encrypting data, according to the present invention. The method 100 is initialized at step 102 and proceeds to step 104, where the method 100 receives an implicit security parameter. In step 106, the method 100 generates one or more public parameters PK and a master key MK based on the implicit security parameter. In one embodiment, generation of the public parameters PK and the master key MK is accomplished using a randomized algorithm that takes no input other than the implicit security parameter.

In step 108, the method 100 receives a message m and a set of attributes γ. A message comprises any data to be encrypted, while the attributes are attributes of a ciphertext created from the message m. The method 100 then proceeds to step 110 and generates a ciphertext E based on the message m, the set of attributes γ, and the public parameters PK. In one embodiment, generation of the ciphertext E is accomplished using a randomized algorithm that takes the message m, the set of attributes γ, and the public parameters PK as input.

In step 112, the method 100 receives an access structure A pertaining to the message m and including non-empty subsets of the attributes γ. The method 100 then proceeds to step 114 and generates a decryption key D based on the access structure A, the master key MK, and the public parameters PK. In one embodiment, generation of the decryption key D is accomplished using a randomized algorithm that takes the access structure A, the master key MK, and the public parameters PK as input.

In step 116, the method 100 outputs the ciphertext E, the decryption key D, and the public parameters PK. The method 100 then terminates in step 118.

Although FIG. 1 illustrates steps of the method 100 as occurring in a certain sequence, those skilled in the art will appreciate that the steps of the method 100 need not necessarily occur in the order illustrated. For instance, the pair of steps 112 and 114 could occur before the pair of steps 108 and 110. Thus, FIG. 1 does not illustrate a mandatory sequential order.

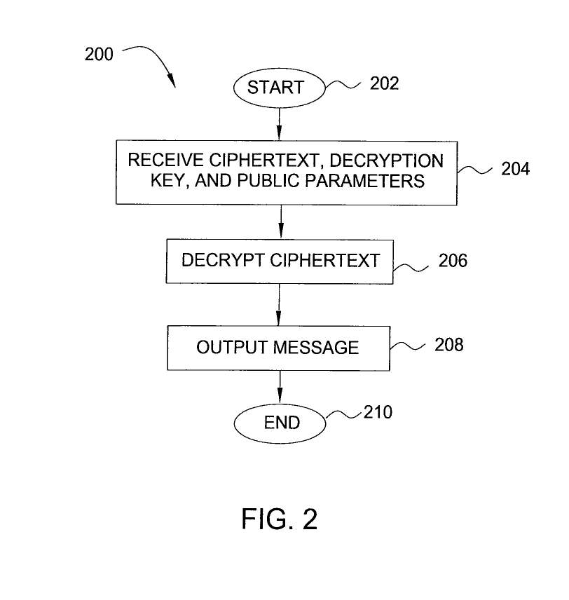

FIG. 2 illustrates on embodiment of a method 200 for decrypting data, according to the present invention. In particular, the method 200 may be implemented to decrypt data that has been encrypted in accordance with the method 100 discussed above.

The method 200 is initialized at step 202 and proceeds to step 204, where the method 200 receives the ciphertext E that was encrypted under the set of attributes γ, the decryption key D for access control structure A, and the public parameters PK.

In step 206, the method 200 decrypts the ciphertext E. In one embodiment, decryption is accomplished using a randomized decryption algorithm that takes the ciphertext E, the decryption key D, and the public parameters PK as input. Decryption based on these inputs will generate the message m if γεA.

In step 208, the method 200 outputs the message m. The method 200 then terminates in step 210.

The security of a system implementing the methods 100 and 200 discussed above can be observed by defining a selective-set model for proving the security of the methods 100 and 200 under chosen plaintext attack.

As a first step of this model, an “adversary” declares the set of attributes, γ, that he wishes to be challenged upon. A challenger then generates one or more public parameters PK and a master key MK (e.g., in accordance with step 106 of the method 100) and gives the public parameters PK to the adversary.

The adversary is allowed to issue queries for private keys for many access structures Aⱼ, where γεAⱼ for all j. The adversary submits two equal length messages M₀ and M₁. The challenger flips a random coin b, and encrypts M_{b} with the set of attributes γ (e.g., in accordance with step 110 of the method 100). The resultant ciphertext E_{b} is passed to the adversary. The issuance of queries for private keys, the submission of messages, and the encryption of a message is then repeated at least once.

After at least two iterations of the issuance of queries for private keys, the submission of messages, and the encryption of a message, the adversary proposes a guess b′ of b.

The advantage of the adversary in this model is defined as Pr[b′=b]−½. The model can easily be extended to handle chosen-ciphertext attacks by allowing for decryption queries in iterations of the issuance of queries for private keys, the submission of messages, and the encryption of a message.

An attribute-based encryption scheme is therefore secure in the Selective-Set model of security if all polynomial time adversaries have at most a negligible advantage in the Selective-Set game. The actual advantage of an adversary will depend on the selected security parameter; as the security parameter grows, the adversary's advantage shrinks exponentially.

As discussed above, the access structures A in embodiments of the present invention are implemented as tree access structures. Embodiments of these tree access structures are constructed in accordance with bilinear maps.

With respect to efficiently computable bilinear maps, a few facts are helpful. If, for instance, G₁ and G₂ are two multiplicative cyclic groups of prime order p, g is a generator of G₁, e is a bilinear map, e: G₁×G₁→G₂, then the bilinear map e has the following properties:

1: Bilinearity: for all u, v ε G₁ and a, b ε Zₚ, one has e(u^{a}, v^{b})=e(u, v)^{ab}.
2: Non-degeneracy: e(g, g)≠1.

G₁ is said to be a bilinear group if the group operation in G₁ and the bilinear map e: G₁×G₁→G₂ are both efficiently computable (e.g., a modern desktop computer could, for a common security parameter, compute the group operation in G₁ and the bilinear map e: G₁×G₁→G₂ in less than approximately ten milliseconds). The map e is symmetric since e(g^{a}, g^{b})=e(g, g)^{ab}=e(g^{b}, g^{a}).

If a, b, c, z ε Zₚ are chosen at random and g is a generator of G₁, then the decisional Bilinear Diffie-Hellman (BDH) assumption is that no probabilistic polynomial-time algorithm β can distinguish the tuple (A=g^{a}, B=g^{b}, C=g^{c}, e(g, g)^{abc}) from the tuple (A=g^{a}, B=g^{b}, C=g^{c}, e(g, g)^{z}) with more than a negligible advantage. The advantage of β is:

|Pr[β(A,B,C,e(g,g)^{abc})=0]Pr[β(A, B, C, e(g,g)^{z})]=0|

where the probability is taken over the random choice of the generator g, the random choice of a, b, c, z in Zₚ, and the random bits consumed by β.

In a linear secret-sharing scheme (LSSS) realizing an access structure A, a third party called a “dealer” holds a secret γ and distributes shares of γ to parties such that γ can be reconstructed by a linear combination of the shares of any authorized set. Further, an unauthorized set has no information about the secret γ. There is a close relation between LSSS and a linear algebraic model of computation called “monotone span programs” (MSP). It has been shown that the existence of an efficient LSSS for some access structure is equivalent to the existence of a small MSP for the characteristic function of that access structure. MSP may thus be defined as follows: If K is a field and {x₁, . . . , xₙ} is a set of variables, a monotone span program over K is labeled matrix \hat{M} (M, ρ) where M is a matrix over K, and ρ is a labeling of the rows of M by literals from {x₁, . . . , xₙ} (every row is labeled by one literal).

A monotone span program accepts or rejects an input by the following criterion. For every input set γ of literals, the submatrix M_{γ} of M is defined as consisting of those rows whose labels are in γ (i.e., rows labeled by some xᵢ such that xᵢεγ. The monotone span program \hat{M} accepts γ if and only if \vec{1}ε span(M_{γ}) (i.e., some linear combination of the rows of M_{γ} gives the all-one vector \vec{1}). The MSP computes a Boolean function f_{M} if it accepts exactly those inputs γ where f_{M}(γ)=1. The size of \hat{M}̂ is the number of rows in M. Again, since the role of parties is assumed by attributes in the context of the present invention, each row of the matrix M will be labeled by an attribute.

As discussed above, in the access-tree construction, ciphertexts are labeled with a set of descriptive attributes. Private keys are identified by a tree-access structure in which each interior node of the tree access structure is a threshold gate and the leaves of the tree access structure are associated with attributes. This setting is very expressive. For example, one can represent a tree with “AND” and “OR” gates by using respectively 2 of 2 and 1 of 2 threshold gates. A user will be able to decrypt a ciphertext with a given key if and only if there is an assignment of attributes from the ciphertexts to nodes of the tree access structure associated with the key such that the tree is satisfied.

Specifically, if τ is a tree representing an access structure, each non-leaf node of the tree represents a threshold gate, described by its children and by a threshold value. If numₓ is the number of children of a node x and kₓ is the threshold value of node x, then 0<kₓ≦numₓ. When kₓ=1, the threshold gate is an OR gate and when kₓ=numₓ, the threshold gate is an AND gate. Each leaf node of the tree τ is described by an attribute and a threshold value kₓ=1.

Several functions are defined to facilitate working with the access tree structures. The parent of the node x in the access tree is denoted by parent(x). The function att(x) is defined only if the node x is a leaf node and denotes the attribute associated with the leaf node x in the access tree. The access tree τ also defines an ordering between the children of every node; that is, the children of a node are numbered from 1 to num. The function index(x) returns the one of such numbers that is associated with the node x, where the index values are uniquely assigned to nodes in the access tree structure for a given key in an arbitrary manner.

If τ is an access tree with root r, τₓ denotes the subtree of τ rooted at the node x. Hence, τ is the same as τᵣ. If a set of attributes γ satisfies the access tree τₓ, the set of attributes is denoted as τₓ(γ)=1.τₓ(γ) is computed recursively as follows: If x is a non-leaf node, evaluate τ_{x′}(γ) for all children x′ of node x. τₓ(γ) returns 1 if and only if at least kₓ children return 1. If x is a leaf node, then τₓ(γ) returns 1 if and only if att(x)ετₓ(γ).

Let G₁ be a bilinear group of prime order p, and let g be a generator of G₁. In addition, let e: G₁×G₁→G₂ denote the bilinear map. A security parameter, κ, will determine the size of the groups. The Lagrange coefficient Δ_{i,s} is defined for i εZₚ and a set, S, of elements is defined in

$${Z}_{p} \text{:} {Δ}_{i , S} ( x ) = {∐}_{j ∈ S , j \neq i} \frac{x - j}{i - j} .$$

Each attribute is associated with a unique element in Z*_{P}.

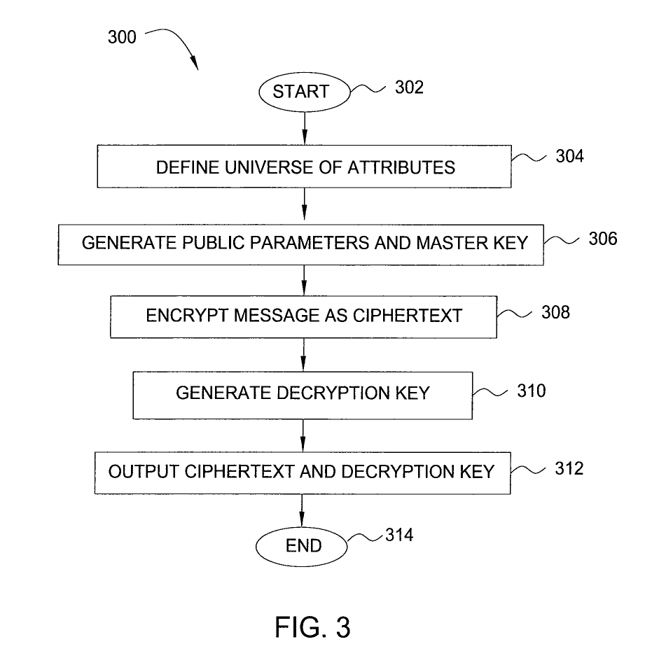

FIG. 3 is a flow diagram illustrating a second embodiment of a method 300 for encrypting data, according to the present invention. Specifically, the method 300 is a modification of the method 100 that accounts for the definitions discussed above.

The method 300 is initialized at step 302 and proceeds to step 304, where the method 300 defines the universe of attributes U={1, 2, . . . , n}. In one embodiment, definition of the attributes involves choosing, for each attribute i εU, a number tᵢ uniformly at random from Zₚ. In addition, a variable γ is chosen uniformly at random in Zₚ.

In step 306, the method 300 generates public parameters PK and a master key MK. In one embodiment, the public parameters PK are:

T₁=g^{t}^{₁}, . . . , T_{|U|}=g^{t|U|},Y=e(g,g)^{y}

and the master key MK is:

t₁, . . . , t_{|U|},y.

In step 308, the method 300 encrypts a message MεG₂ under a set of attributes γ. In one embodiment, the message M is encrypted by choosing a random value sεZₚ. In step 310, the method 300 generates a ciphertext as:

E=(γ,E′=MY^{S},{Eᵢ=Tᵢ^{S}}_{iεγ}).

In step 312, the method 300 generates a key that enables the user to decrypt a message encrypted under a set of attributes γ if and only if τ(γ)=1.

In one embodiment, the key is generated by first choosing a polynomial qₓ for each node x (including leaf nodes) in the access tree τ.

In one embodiment, the polynomials qₓ are chosen in a top-down manner, starting from the root node r. For each node x in the access tree, the degree dₓ of the polynomial qₓ is set to be one less than the threshold value kₓ of the node, that is, dₓ=kₓ−1. For the root node r, qᵣ(0) is set equal to γ and dᵣ is set equal to other points of the polynomial qᵣ randomly to define qᵣ completely. For any other node x, set qₓ(0) is set equal to qₚₐᵣₑₙₜ₍ₓ₎(index(x)) and dₓ is chosen to be equal to other points randomly to completely define qₓ.

In step 314, having defined the polynomials, the method 300 outputs, for each leaf node x, the following secret values along with the ciphertext:

$${D}_{x} = {g}^{\frac{{q}_{x} ( 0 )}{{t}_{i}}}$$

where i=att(x). This set of secret values is the decryption key D. The method 300 then terminates in step 316.

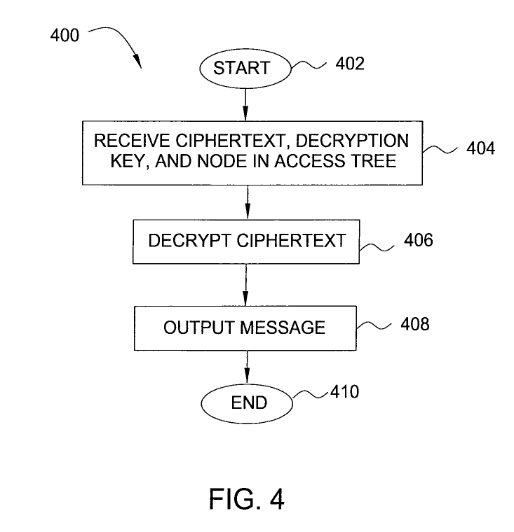

FIG. 4 is a flow diagram illustrating a method 400 for decrypting data, according to the present invention. In particular, the method 400 may be implemented to decrypt data that has been encrypted in accordance with the method 300 discussed above. In one embodiment, steps of the method 400 resemble a recursive algorithm. For ease of exposition, the simplest form of the decryption method 400 is described.

The method 400 is initialized at step 402 and proceeds to step 404, where the method 400 receives a ciphertext E=(γ,E′, {Eᵢ}_{iεγ}), a private decryption key D (where the access tree τ is assumed to be embedded in the private decryption key), and a node x in the access tree τ.

In step 406, the method 400 decrypts the ciphertext E. If i=att(x) and the node x is a leaf node, then:

$$DecryptNode ( E , D , x ) = \{ \begin{matrix}e ( {D}_{x} , {E}_{i} ) = e ( {g}^{\frac{{q}_{x} ( 0 )}{{t}_{i}}} , {g}^{s \cdot {t}_{i}} ) = {e ( g , g )}^{s \cdot {q}_{x} ( 0 )} if i ∈ γ \\ ⊥ otherwise\end{matrix}$$

If x is a non-leaf node, decryption proceeds as follows: For all nodes z that are children of x, the method 400 calls DecryptNode(E,D, z) and stores the output as F_{z}. Sₓ is an arbitrary kₓ-sized set of child nodes z such that F_{z}≠l. If no such set exists, then the node z was not satisfied and the function returns l.

Otherwise, the following is computed:

$$\begin{matrix}{F}_{x} = {\prod }_{z ∈ {S}_{x}} {F}_{z}^{{Δ}_{i , {s}_{x}^{′}} ( 0 )} , where \begin{matrix}i = index ( z ) \\ {s}_{x}^{′} = \{ index ( z ) \text{:} z ∈ {S}_{x} \}\end{matrix} \\ = {\prod }_{z ∈ {S}_{x}} {( {e ( g , g )}^{s \cdot {q}_{z} ( 0 )} )}^{{Δ}_{i , {s}_{x}^{′}} ( 0 )} \\ = {\prod }_{z ∈ {S}_{x}} {( {e ( g , g )}^{s \cdot {q}_{parent ( z )} ( index ( z ) )} )}^{{Δ}_{i , {s}_{x}^{′}} ( 0 )} ( by construction ) \\ = {\prod }_{z ∈ {S}_{x}} {e ( g , g )}^{s \cdot {q}_{x} ( i ) \cdot {Δ}_{i , {s}_{x}^{′}} ( 0 )} \\ = {e ( g , g )}^{s \cdot {q}_{x} ( 0 )} ( using polynomial interpolation )\end{matrix}$$

and the method 400 returns the result. Thus, decryption in accordance with step 406 may be performed on the root node r of the access tree τ. It is observed that DecryptNode(E, D, r)=e(g,g)^{ys}=Y^{s} if and only if the ciphertext E satisfies the access tree τ. Since E′=MY^{s}, decryption in accordance with step 406 simply divides out Y^{s} and recovers the message M.

In step 408, the method 400 outputs the message M, which is a group element of G₂ or l. The method 200 then terminates in step 210.

Encryption methods according to the present invention may be applied to any LSSS-realizable access structure. For instance, consider an access structure for which there exists a linear secret-sharing scheme that realizes the access structure. It is known that for every LSSS-realizable access structure, there exists a monotone span program (MSP) that computes the corresponding Boolean function, and vice versa. Thus, such an access structure can be represented by a monotone span program.

In order to accommodate more general and complex access structures, embodiments of the present invention apply attribute based encryption for the class of access structures which can be represented by polynomial size monotone span programs. The access structure is represented in the form of a monotone span program \hat{M} (M, ρ). Each row of M is labeled by an attribute from U and ρ(i) denotes the label of iₜₕ row \vec{M}ᵢ.

The data is encrypted under a set of attributes γ. The user should be able to decrypt the data if and only if he holds the keys for an MSP \hat{M} (M, ρ) such that f_{M}(γ)=1; where f_{M} denotes the function that \hat{M} computes.

G₁ is a bilinear group of prime order p, and g is generator of G₁. Additionally, e: G₁×G₁→G₂ denotes the bilinear map. A security parameter, κ, will determine the size of the groups.

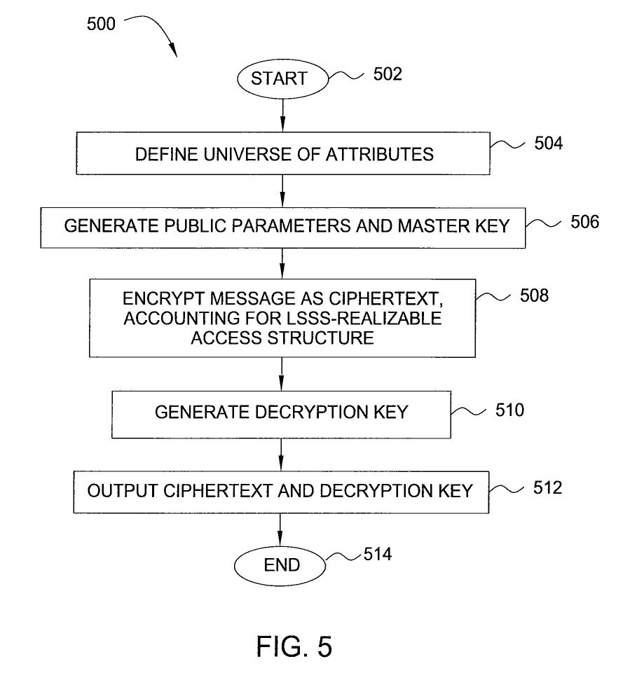

FIG. 5 is a flow illustrating a third embodiment of a method 500 for encrypting data, according to the present invention. Specifically, the method 500 is a modification of the method 100 that accounts for any LSSS-realizable access structure as discussed above.

The method 500 is initialized in step 502 and proceeds to step 504, where the method 500 defines the universe of attributes U={1, 2, . . . , n}. In one embodiment, definition of the attributes involves choosing, for each attribute iεU, a number tᵢ uniformly at random from Zₚ. In addition, a variable γ is chosen uniformly at random in Zₚ.

In step 506, the method 500 generates public parameters PK and a master key MK. In one embodiment, the published public parameters PK are:

T₁=g^{t}^{₁}, . . . , T_{|U|}=g^{t}^{_{|U|}},Y=e(g,g)^{y}

The master key MK is:

t₁, . . . t_{|U|},y.

In step 508, the method 500 encrypts a message mεE G₂ under the set of attributes γ. In one embodiment, the message m is encrypted by choosing a random value sεE Zₚ. In step 510, the method 500 generates a ciphertext as:

E=(γ,E′=MY^{s},{Eᵢ=Tᵢ^{s}}_{iεγ}).

In step 512, the method 500 generates a private decryption key D. In one embodiment, the private decryption key D is generated based on an input access structure in the form of an MSP \hat{M} (M,ρ), where the dimensions of M is d×1. A random vector \vec{u} is chosen from Zₚ¹ such that \vec{1}·\vec{u}=y, that is, U=(u₁, u₂, . . . u₁) such that Σᵢ₌ₗ^{l}uᵢ=y.

In step 514, the method 500 outputs the private decryption key D along with the ciphertext. For each row vector \vec{M}ᵢ, the method 500 outputs the following secret value:

$${D}_{i} = {g}^{\frac{{\vec{M}}_{i} \cdot \vec{u}}{{t}_{ρ ( i )}}}$$

where the set of secret values is the decryption key D. The method 500 then terminates in step 516.

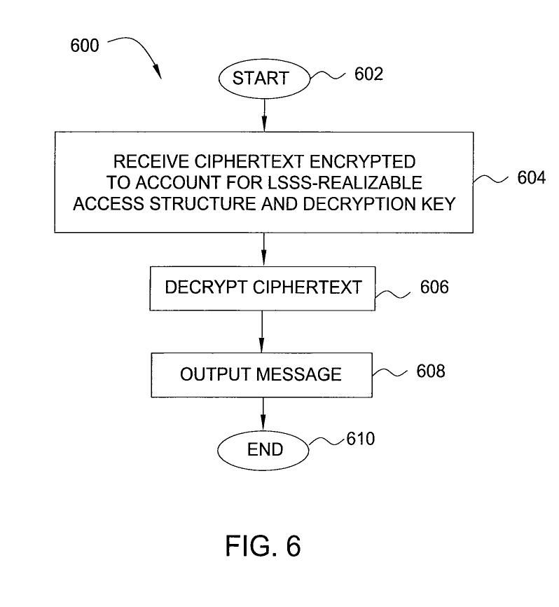

FIG. 6 is a flow diagram illustrating a method 600 for decrypting data, according to the present invention. In particular, the method 600 may be implemented to decrypt data that has been encrypted in accordance with the method 500 discussed above.

The method 600 is initialized at step 602 and proceeds to step 604, where the method 600 receives a ciphertext E=(γ,E′,{Eᵢ}_{iεγ}) and a decryption key D.

In step 506, the method 500 decrypts the ciphertext E. Since f_{M}(γ)=1, the span program \hat{M} accepts γ. Thus, there exist coefficients αᵢεZₚ such that,

$${\sum }_{ρ ( i ) ∈ y} {α}_{i} \cdot {\vec{M}}_{i} = \vec{1}$$

Now,

$$\begin{matrix}{E}^{′} {\prod }_{ρ ( i ) ∈ γ} {e ( {D}_{i} , {E}_{ρ ( i )} )}^{{α}_{i}} = {E}^{′} {\prod }_{ρ ( i ) ∈ γ} {e ( {g}^{\frac{{\vec{M}}_{i} \cdot \vec{u}}{{t}_{ρ ( i )}}} , {g}^{{st}_{ρ} ( i )} )}^{{α}_{i}} \\ = {mY}^{s} / {\prod }_{ρ ( i ) ∈ y} {e ( g , g )}^{s \cdot {α}_{i} \cdot {\vec{M}}_{i} \cdot \vec{u}} \\ = {mY}^{s} / {e ( g , g )}^{s \cdot ( {Σ}_{ρ ( i ) ∈ γ} {α}_{i} \cdot {\vec{M}}_{i} ) \cdot \vec{u}} \\ = {mY}^{s} / {e ( g , g )}^{s \cdot ( \vec{1} \cdot \vec{u} )} \\ = {me ( g , g )}^{sy} / {e ( g , g )}^{sy} \\ = m\end{matrix}$$

The method 600 outputs the message m in step 508 before terminating in step 610.

In the constructions discussed above, the size of public parameters PK grows linearly with the number of possible attributes γ in the universe. The methods discussed above can further extended to large universe applications that use all elements of Z*ₚ as attributes, yet in such embodiments the public parameters PK grow only linearly in a parameter n which is fixed as the maximum size of the set that can be encrypted under.

Large universe construction not only reduces the size of the public parameters PK but also enables application of a collision resistant hash function H: {0,1}*→Z*ₚ and use of arbitrary strings, that were not necessarily considered during public key setup, as attributes. For example one can add any verifiable attribute, such as \“Lives in Beverly Hills,” to a user's private key.

Let G₁ be a bilinear group of prime order p, and let g be a generator of G₁. Additionally, e: G₁×G₁→G₂ denotes the bilinear map. A security parameter, κ, will determine the size of the groups. A Lagrange coefficient Δ_{i,s} is also defined for iεZₚ,as well as a set, S, of elements in Zₚ, as before. The data will be encrypted under a set γ of n elements of Z*ₚ.

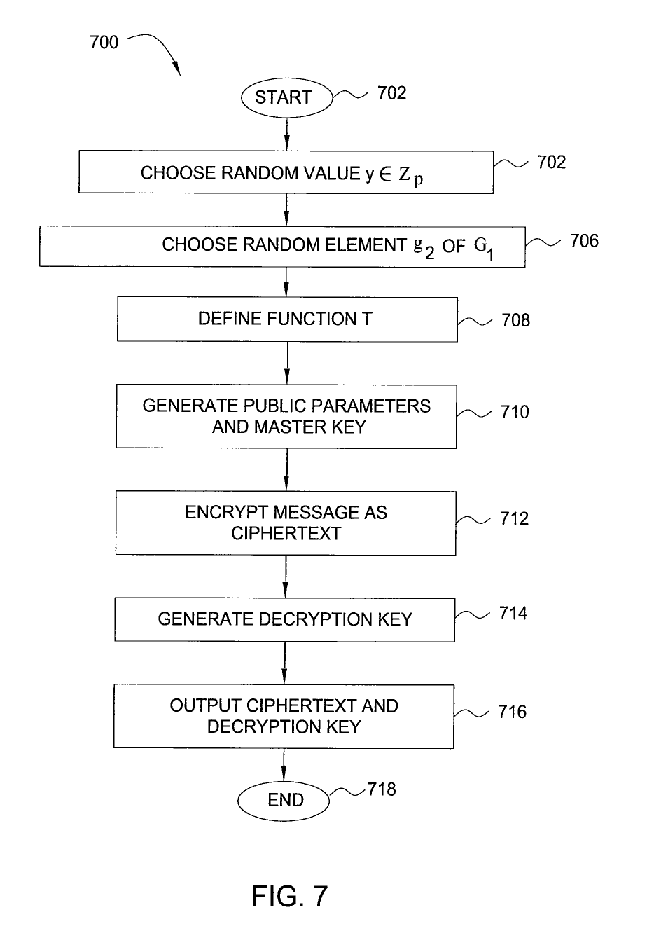

FIG. 7 is a flow diagram illustrating a fourth embodiment of a method 700 for encrypting data, according to the present invention. Specifically, the method 700 is a modification of the method 100 that accounts for large universe applications.

The method 700 is initialized at step 702 and proceeds to step 704, where the method 700 chooses a random value yεZₚ. Further, g₁ is set such that g₁=g_{y}.

In step 706, the method 700 chooses a random element g₂ of G₁ and chooses t₁, . . . , tₙ₊₁ uniformly at random from G₁. N is set as the set {1, 2, . . . , n+1}.

In step 708, the method 700 defines a function T, as:

$$T ( X ) = {g}_{2}^{{X}_{n}} {\prod }_{i = 1}^{n + 1} {t}_{i}^{{Δ}_{i , N} ( X )}$$

where the function T can be viewed as the function g₂^{X}^{ₙ}g^{h(X)} for some n degree polynomial h.

In step 710, the method 700 generates the public parameters PK and the master key MK. The public parameters PK are: g₁, g₂, t₁, . . . , tₙ₊₁ and the master key MK is: y.

In step 712, the method 700 encrypts a message mεG₂ under a set of attributes γ. In one embodiment, encryption of the message m is performed by choosing a random value sεZₚ. The ciphertext is thus generated as:

E=(γ,E′=me(g₁,g₂)^{s},E″=g^{s},{Eᵢ=T(i)^{s}}_{iεγ}).

In step 714, the method 700 generates a key which enables a user to decrypt the message m encrypted under a set of attributes γ, if and only if τ(γ)=1. In one embodiment, the key is generated by first choosing a polynomial qₓ for each non-leaf node x in the access tree τ.

These polynomials are chosen in a top down manner, starting from the root node r. For each node x in the access tree, set degree dₓ of the polynomial qₓ is set to be one less than the threshold value kₓ of that node x, that is, dₓ=kₓ−1. For the root node r, qᵣ(0) is set such that qᵣ(0)=y and dᵣ is set such that other points of the polynomial qᵣ randomly define qᵣ completely. For any other node x, qₓ(0) is set such that qₓ(0)=qₚₐᵣₑₙₜ₍ₓ₎(index(x)) and dₓ is chosen such that other points randomly completely define qₓ completely.

In step 716, the method 700 outputs the decryption key D along with the ciphertext before terminating in step 718. Once the polynomials have been decided, for each leaf node x, the method 700 outputs the following secret values:

Dₓ=g₂^{q}^{ₛ}⁽⁰⁾·T(i)^{r}^{ₓ} where i=att(x)

Rₓ=g^{r}^{ₓ}

where rₓ is chosen uniformly at random from Zₚ for each node x. The set of above secret pairs is the decryption key D.

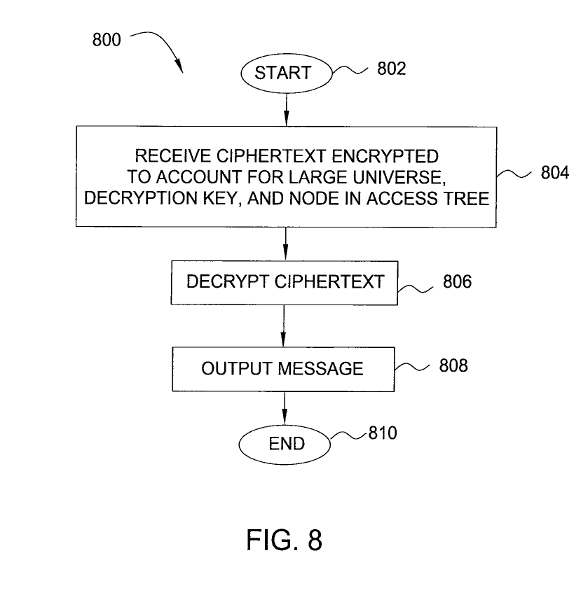

FIG. 8 is a flow diagram illustrating one embodiment of a method 800 for decrypting data, according to the present invention. In particular, the method 800 may be implemented to decrypt data that has been encrypted in accordance with the method 700 discussed above. As in the small-universe case, steps of the method 800 implement a recursive algorithm.

The method 800 is initialized at step 802 and proceeds to step 804, where the method 800 receives a ciphertext E=(γ, E′, E″, {Eᵢ}ᵢε₆₅), a private decryption key D (where the access tree τ is assumed to be embedded in the private decryption key), and a node x in the access tree τ.

In step 806, the method 800 decrypts the ciphertext E. If i=att(x) and the node x is a leaf node, then:

$$DecryptNode ( E , D , x ) = \{ \begin{matrix}\frac{e ( {D}_{x} , {E}^{″} )}{e ( {R}_{x} , {E}_{i} )} = \frac{\begin{matrix}e ( {g}_{2}^{{q}_{x} ( 0 )} \cdot \\ {T ( i )}^{{r}_{x} , {g}^{s}}\end{matrix}}{e ( {g}^{{r}_{x}} , {T ( i )}^{s} )} = \frac{\begin{matrix}e ( {g}_{2}^{{q}_{x} ( 0 )} \cdot {g}^{s} ) \cdot \\ e ( {T ( i )}^{{r}_{x} , {g}^{s}} )\end{matrix}}{e ( {g}^{{r}_{x}} , {T ( i )}^{s} )} = {e ( g , {g}_{2} )}^{s \cdot {q}_{x} ( 0 )} if i ∈ γ \\ ⊥ otherwise\end{matrix}$$

If x is a non-leaf node, decryption proceeds as follows: For all nodes z that are children of x, the method 800 calls DecryptNode (E,D, z) and stores the output as F_{z}. Sₓ is an arbitrary kₓ-sized set of child nodes z such that F_{z}≠l. If no such set exists, then the node z was not satisfied and the function returns l.

Otherwise, the following is computed:

$$\begin{matrix}{F}_{x} = {\prod }_{z ∈ {S}_{x}} {F}_{z}^{{Δ}_{i , {s}_{x}^{′}} ( 0 )} , where \begin{matrix}i = index ( z ) \\ {s}_{x}^{′} = \{ index ( z ) \text{:} z ∈ {S}_{x} \}\end{matrix} \\ = {\prod }_{z ∈ {S}_{x}} {( {e ( g , g )}^{s \cdot {q}_{z} ( 0 )} )}^{{Δ}_{i , {s}_{x}^{′}} ( 0 )} \\ = {\prod }_{z ∈ {S}_{x}} {( {e ( g , g )}^{s \cdot {q}_{parent ( z )} ( index ( z ) )} )}^{{Δ}_{i , {s}_{x}^{′}} ( 0 )} ( by construction ) \\ = {\prod }_{z ∈ {S}_{x}} {e ( g , g )}^{s \cdot {q}_{x} ( i ) \cdot {Δ}_{i , {s}_{x}^{′}} ( 0 )} \\ = {e ( g , g )}^{s \cdot {q}_{x} ( 0 )} ( using polynomial interpolation )\end{matrix}$$

and the method 800 returns the result. Thus, decryption in accordance with step 806 may be performed on the root node r of the access tree τ. It is observed that DecryptNode(E, D, r)=e(g,g₂)^{YS}=e(g₁,g₂)^{S} if and only if the ciphertext E satisfies the access tree τ. Since E′=me(g₁,g₂)S, decryption in accordance with step 406 simply divides out e(g₁,g₂)S and recovers the message m.

In step 808, the method 800 outputs the message m, which is a group element of G₂ or l. The method 800 then terminates in step 810.

It is possible to extend the methods 700 and 800 to realize any LSSS-realizable access structure using similar techniques. In such a case, steps 702-712 of the method 700 remain substantially the same. However, step 714 takes an MSP and the master key MK as input. For each row i of the matrix, the method 700 outputs the following pair: (Dᵢ=g₂^{\vec{M}}^{ᵢ}^{\vec{u}}·T(i)^{r}^{ᵢ},Rᵢ=g^{r}^{ᵢ}); where \vec{u} is chosen such that \vec{1}·\vec{u}=y (master key), and rᵢ is chosen randomly. Decryption can be achieved following substantially the same method described with reference to FIG. 6.

In embodiments of the large universe construction, individual users can generate new private keys using their private keys, and the new private keys can then be delegated to other users. A user who has a private key corresponding to an access tree τ can compute a new private key corresponding to ANY access tree τ′ which is more restrictive than τ(i.e., τ′⊂τ). Thus, a user acts as a local key authority who can generate and distribute private keys to other users.

In one embodiment, computation of a new private key from an existing private key is done by applying a set of basic operations on the existing private key. These operations are aimed at step-by-step conversion of the existing private key for an access tree τ to a new private key for the targeted access tree τ (given that τ⊂τ). In the following, a (t, n)-gate denotes a gate with threshold t and n children.

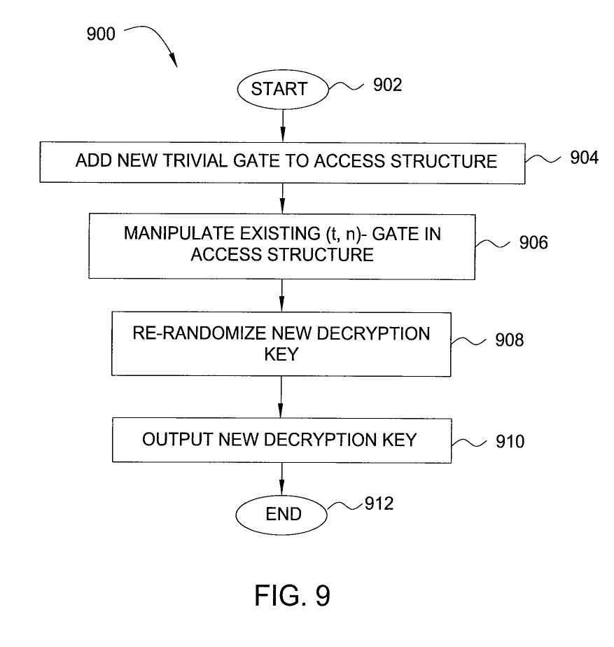

FIG. 9 is a flow diagram illustrating one embodiment of a method 900 for computing a new private key from an existing private key. The method is initialized at step 902 and proceeds to step 904, where the method 900 adds a new trivial gate to the access tree τ associated with the existing private key. In one embodiment, this operation involves adding a new node y above an existing node x. The new node y represents a (1, 1) threshold gate which, once added, becomes the parent of the existing node x. The former parent of x (if x is not the root node), say z, becomes the parent of y.

Since the threshold of the node y is 1, one is required to associate a zero-degree polynomial q_{y} with the node y such that qₓ(0)=q_{y}(x)) and q_{y}(0)=q_{z}(y)). The second condition essentially fixes q_{y} and the first condition is automatically satisfied since z was formerly the parent of the existing node x before the addition of node y. Hence, no changes to the private key are required for this operation.

In step 906, the method 900 manipulates an existing (t, n)-gate in the access tree τ. In one embodiment, this operation involves manipulating a threshold gate so as to make the access structure more restrictive. The operation could be any one of three types.

In a first embodiment, the (t, n)-gate is converted to a (t+1, n)-gate with (t+1) n. Consider a node x representing a (t, n)-gate. Clearly, the polynomial qₓ has the degree (t−1), which has to be increased to t. A new polynomial q is defined as follows:

q′ₓ(X)=(X+1)qₓ(X)

Next, the key is changed such that q′ₓ becomes the new polynomial of the existing node x. In one embodiment, this is done as follows: For every child y of x, the constant Cₓ=y)+1 is computed. For every leaf node z in the subtree τ_{y}, the new decryption key is computed as

D′_{y}=D_{y}·g₂^{c}^{_{y}}·T9i)^{r}^{_{y}},R_{y}′=R_{y}·g^{r}^{_{y}}

The above results in the multiplication of all the polynomials in the subtree τ_{y} with the constant Cₓ. Hence, q′_{y}(0)=(y)+1)q_{y}(0), which is indeed a point on the new polynomial q′ₓ. Its is noted that since q′ₓ(0)=qₓ(0), no changes outside the subtree τₓ are required.

The above procedure effectively changes the existing node x from a (t, n)-gate to a (t+1, n)-gate and yields the corresponding new private key.

In a second embodiment, a (t, n)-gate is converted to a (t+1, n+1)-gate. In one embodiment, this procedure involves adding a new subtree (with root, say, z) as a child of an existing node x while at the same time increasing the degree of the existing node x by 1. z is denoted the v^{th} child of x, so that z=v. The polynomial qₓ is changed to the following.

$${q}_{x}^{′} ( X ) = ( aX + 1 ) {q}_{x} ( X ) , \\ where$$

$$a = \frac{- 1}{v} .$$

As in the first embodiment, for every existing child y of the existing node x, the polynomials in the subtree τ_{y} are multiplied with the appropriate constant Cₓ=a·y)+1. This ensures that q′_{y}(0) is indeed a point on q′ₓ. Further, q_{z}(0) is set as q_{z}(0)=0 (=q′ₓ(v)). Given q_{z}(0), keys can be created for the subtree τ_{z} as in the key generation algorithm described above. Hence, the keys of the subtrees of all children (old as well as new) of the existing node x have been made consistent with the new polynomial q′ₓ.

In a third embodiment, a (t, n)-gate is converted to a (t, n−1)-gate with t≦(n−1). In one embodiment, this operation involves deleting a child y of an existing node x. This can be easily achieved just by deleting decryption keys corresponding to all the leaves of the subtree τ_{y} from the original decryption key.

In step 908, the method 900 re-randomizes the obtained new decryption key. In one embodiment, once a key for the desired access structure is obtained (e.g., via steps 904-906), the method 900 applies a final re-randomization step to make the new key independent of the original key from which it was computed. In one embodiment, re-randomization of a node x with a (known) constant Cₓ is done as follows: A random polynomial Pₓ of degree dₓ is chosen such that pₓ(0)=Cₓ. The new polynomial q′ₓ is defined as q′ₓ(X)=qₓ(X)+pₓ(X). The key is changed such that q′ₓ becomes the new polynomial of the node x. In one embodiment, this is done by recursively re-randomizing every child y of the node x with the constant C_{y}=Pₓ(y)). If y is a leaf node, the new decryption key corresponding to y is computed as:

D′_{y}=D_{y}·g₂^{C}^{_{y}}·T(i)^{r}^{_{y}},R′_{y}·g^{r}^{_{y}}

where i=att(y) and r_{y} is chosen randomly.

Now, re-randomization of the private key is done just by re-randomizing the root node r with the constant Cᵣ=0. The key obtained is the final key ready to be distributed to other users. The method 900 outputs this final key in step 910. The method 900 then terminates in step 912.

The encryption methods of the present invention may find use in a variety of applications. One important application of attribute-based encryption deals with secure forensic analysis. One of the most important needs for electronic forensic analysis is an “audit log” containing a detailed account of all activity on a system or network to be protected. Such audit logs, however, raise significant security concerns; a comprehensive audit log would become a prized target for an individual wishing to compromise the system or network. Merely encrypting the audit log is not sufficient, since any party who needed to legitimately access the audit log contents (for instance a forensic analyst) would require the secret key—thereby giving this single analyst access to essentially all secret information on the system or network. Such problematic security issues arise in nearly every secure system, and particularly in large-scale networked systems such as the Global Information Grid, where diverse secret, top secret, and highly classified information will need to appear intermingled in distributed audit logs.

The present invention provides an attractive solution to the audit log problem. Audit log entries can be annotated with attributes (such as, for instance, the name of the user, the date and time of the user action, and the type of data modified or accessed by the user action). Then, a forensic analyst charged with some investigation would be issued a secret key associated with a particular “access structure”—which would correspond to the key allowing for a particular kind of encrypted search (such a key, for example, would only open audit log records whose attributes satisfied the condition that “the user name is Bob, OR (the date is between Oct. 4, 2005 and Oct. 7, 2005 AND the data accessed pertained to naval operations off the coast of North Korea)”. Embodiments of the present invention would substantially ensure that even if multiple rogue analysts colluded to try to extract unauthorized information from the audit log, they would fail.

Embodiments of the present invention can also be applied to broadcast encryption. For example, consider a new broadcast scenario referred to herein as “targeted broadcast,” and consider the following setting: A broadcaster broadcasts a sequence of different items, each item labeled with a set of attributes describing the item. For instance, a television broadcaster might broadcast an episode of television show X, and label this item with attributes such as the name of the program (“X”), the genre (“drama”), the season, the episode number, the year, month, and date of original broadcast, the current year, month, and date, the name of the director, and the name of the producing company.

Each user of the targeted broadcast system is subscribed to a different “package.” A user's package describes an access policy, which along with the set of attributes describing any particular item being broadcast, determines whether or not the user should be able to access the item. For example, a television user may want to subscribe to a package that allows him view episodes of “X” from either the current fifth season or from Season 3. This could be encoded as policy as (“X” AND (“Season:5” OR “Season:3”)).

The essential idea of targeted broadcast is to enjoy the economies-of-scale offered by a broadcast channel, while still being able to deliver programming targeted at the needs or wishes of individual users. The growing acceptability of such a model can be seen by the rising popularity of digital video recorder (DVR) systems, which allow users to easily record only the programming they want and to watch it at a later time. In the case of television, taking the approach described here would allow for much more flexibility than just allowing users to select what channels they like.

Embodiments of the present invention naturally offer a targeted broadcast system. A new symmetric key would be chosen and used to encrypt each item being broadcast, and then the encrypion system would be used to encrypt the symmetric key with the attributes associated with the item being broadcast. The encryption system would precisely allow the flexibility described in issuing private keys for the unique needs of each user.

Embodiments of the invention can be further extended to achieving Cisco Clean Access (CCA)-Security and hierarchical identity-based encryption (HIBE) using the key delegation techniques described above. In one embodiment, to achieve CCA-2 security, an encyrptor will chooses a set γ of attributes to encrypt the message under and then generate a public/private key pair for a one-time signature scheme.

In this case, VK denotes the bitstring representation of the public key and let γ′ is the set γ ∪VK. The encryptor encrypts the ciphertext under the attributes γ′, signs the ciphertext with the private key, and attaches the signature and the public key description. A user with a key for access structure X would first checks that the ciphertext is signed under VK, and would reject the ciphertext if it is not so signed. The user would then create a new key for the access structure of “X AND CCA:VK.”

A HIBE can be realized by simply managing the assignment of attributes in a careful manner. For example, to encrypt to the hierarchical identity “edu:ucla” one can encrypt to the set of attributes {“1- edu,” “2-ucla”}. An individual who has the top-level key for edu will have a policy that requires the attribute “1-edu” to be present. To delegate a key for “edu:ucla,” the individual simply creates a policy for “1-edu” AND “2-ucla” using the key delegation techniques described above.

Embodiments of the invention can be further extended to searching on encrypted data. However, if it were possible to hide the set of attributes under which the data is encrypted, then viewing attributes as keywords would lead to a general keyword-based search on encrypted data. A search query could potentially be any monotone Boolean formula of any number of keywords.

Embodiments of the invention can be further extended to the setting in which ciphertexts are associated with sets of attributes, whereas user secret keys are associated with policies (e.g., defined by a tree access structure or a monotone span program). As discussed above, this setting has a number of natural applications. Another possibility is the reverse situation: user keys are associated with sets of attributes, whereas ciphertexts are associated with policies. Such systems are herein referred to as “ciphertext-policy attribute-based encryption” (CP-ABE) systems. CP-ABE systems that allow for complex policies (like those considered here) would have a number of applications. An important example is a kind of sophisticated broadcast encryption, where users are described by (and therefore associated with) various attributes. Then, one could create a ciphertext that can be opened only if the attributes of a user match a policy. For instance, in a military setting, one could broadcast a message that is meant to be read only by users who have a rank of Lieutenant or higher, and who were deployed in South Korea in the year 2005. Thus, an encryptor is able to control the individuals who have access to encrypted data, based on attributes of the individuals (as opposed to based on attributes of the data). This shifts the “intelligence” to the encryptor rather than to the issuer of decryption keys.

For example, let G₀ be a bilinear group of prime order p, and let g be a generator of G₀. In addition, let e: G₀×G₀→G₁ denote the bilinear map. A security parameter, K, will determine the size of the groups. The Lagrange coefficient Δ_{i,s} is defined for iεZₚ and a set, S, of elements is defined in

$${Z}_{p} \text{:} {Δ}_{i , S} ( x ) = {\prod }_{j ∈ S , j \neq i} \frac{x - j}{i - j} .$$

A hash function H:{0, 1}*→G₀ is additionally employed and is modeled as a random oracle. The hash function will map any attribute described as a binary string to a random group element.

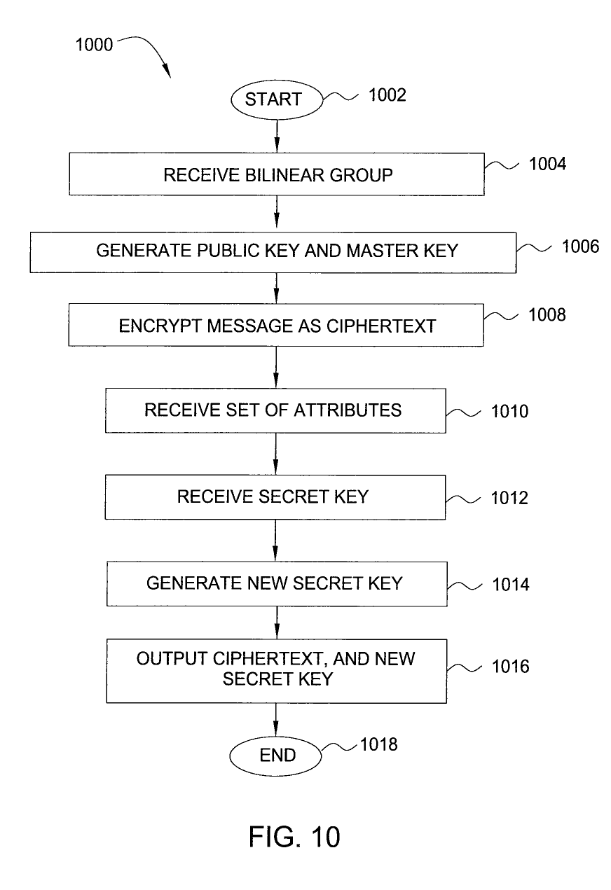

FIG. 10 is a flow diagram illustrating one embodiment of a method 1000 for encrypting data according to the present invention. Specifically, the method 1000 is a method for encrypting data in a CP-ABE system.

The method 1000 is initialized at step 1002 and proceeds to step 1004, where the method 1000 receives a bilinear group G₀ of prime order p with generator g and two random exponents α, βεZₚ.

In step 1006, the method 1000 generates a public key PK and a master key MK. In one embodiment, the public key is published as:

PK=G₀,g,h=g_{β},f=g^{1/β},e(g,g)^{β}

and the master key MK is:

(β,g^{β})

where f is used only for delegation.

In step 1008, the method 1000 encrypts a message M under the tree access structure τ. Although the access structure is described as a tree access structure, those of skill in the art will appreciate that the access structure can be easily generalized to any monotone span program. In one embodiment, the method 1000 first chooses a polynomial qₓ for each node x (including the leaf nodes) in the access tree τ. In one embodiment, these polynomials are chosen in a top-down manner, starting from the root node r of the access tree τ. For each node x in the access tree, the degree dₓ of the polynomial qₓ is set to be one less than the threshold value kₓ of the node x, that is, dₓ=kₓ−1.

Starting with the root node r, the method 1000 chooses a random sεZₚ and sets qᵣ(0)=s. Then, the method 1000 chooses dᵣ other points of the polynomial qᵣ randomly to define qᵣ completely. For any other node x, the method 900 sets qₓ(0)=qₚₐᵣₑₙₜ₍ₓ₎(index(x)) and chooses dₓ other points randomly to completely define qₓ.

If Y is the set of leaf nodes in the access tree τ, the ciphertext CT is constructed by giving the tree access structure τ and computing CT=(τ,\tilde{C}=Me(g,g)^{βs},C=h^{s},∀yεY:C_{y}=g^{q}^{_{y}}^{⁽⁰⁾},C′_{y}=H(att(y))^{q}^{_{y}}^{⁽⁰⁾}).

In step 1010, the method 1000 receives k a set of attributes S. In step 1012, the method 1000 generates a key that identifies with the set of attributes S.

In one embodiment, the method 1000 generates the key by first choosing a random rεZₚ and a random rⱼεZₚ for each attribute jεS. The method 1000 then computes the key as SK=(D=g^{(β+r)b β}, ∀jεS:Dⱼ=g^{r}·H(j)^{r}^{ⱼ},D′ⱼ=g^{r}^{ⱼ}).

In step 1014, the method 1000 receives a secret key SK, which is for a set S of attributes, and another set \tilde{S} of attributes such that \tilde{S}=S. The secret key is of the form SK=(D,∀jεS:Dⱼ,D′ⱼ).

In step 1016, the method 1000 creates a new secret key based on the received secret key SK. In one embodiment, the method 1000 first chooses random \tilde{r} and \tilde{r}ₖ∀kε\tilde{S}. The method 1000 then creates the new secret key as \tilde{S}K=(\tilde{D}=Df^{\tilde{r}},∀kε\tilde{S}:\tilde{D}ₖ=Dₖg^{\tilde{r}}H(k)^{\tilde{r}}ₖ,\tilde{D}′ₖ=D′ₖg^{\tilde{r}}^{ₖ}).

The resulting secret key \tilde{S}K is a secret key for the set of attributes \tilde{S} Since the method 1000 re-randomizes the key, a delegated key is equivalent to a key received directly from an authority.

The method 1000 outputs the ciphertext Ct and the secret key SK in step 1018 before terminating in step 1020.

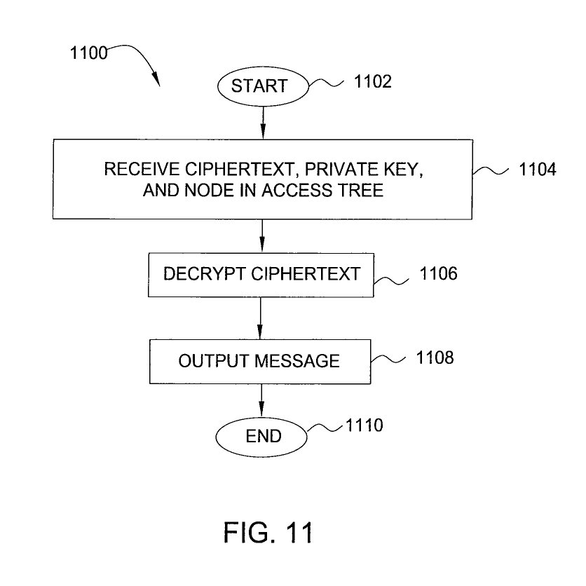

FIG. 11 is a flow diagram illustrating one embodiment of a method 1100 for decrypting data, according to the present invention. In particular, the method 1100 may be implemented to decrypt data that has been encrypted in accordance with the method 1000 discussed above. In one embodiment, steps of the method 1100 implement a recursive algorithm. For ease of exposition, the simplest form of the decryption method 1100 is described.

The method 1100 is initialized at step 1102 and proceeds to step 1104, where the method 1100 receives a ciphertext CT=(τ,\tilde{C},C,∀yεY:C_{y},C′_{y}), a private key SK, which is associated with a set S of attributes, and a node x from the access tree τ.

In step 1106, the method 1100 decrypts the ciphertext CT. If the node x is a leaf node of the access tree τ, then i=att(x) and decryption is performed as follows: If iεS, then

$$\begin{matrix}DecryptNode ( CT , SK , x ) = \frac{e ( {D}_{i} , {C}_{x} )}{e ( {D}_{i}^{′} , {C}_{x}^{′} )} \\ = \frac{e ( {g}^{r} \cdot {H ( i )}^{{r}_{i}} , {h}^{{q}_{x} ( 0 )} )}{e ( {g}^{{r}_{i}} , {H ( i )}^{{q}_{x} ( 0 )} )} \\ = {e ( g , g )}^{{rq}_{x} ( 0 )} . \end{matrix}$$

If i∉S, then DecryptNode(CT,SK, x)=l.

If the node x is a non-leaf node, then decryption proceeds as follows: For all nodes z that are children of x, the method 1100 calls DecryptNode(CT,SK, z) and stores the output as F_{z}. Sₓ is an arbitrary kₓ-sized set of child nodes z such that F_{z}≠l. If no such set exists, then the node x was not satisfied and the function returns l.

Otherwise, the method 1100 computes:

$$\begin{matrix}{F}_{x} = {\prod }_{z ∈ {S}_{x}} {F}_{z}^{{Δ}_{i , {s}_{x}^{′}} ( 0 )} , where \begin{matrix}i = index ( z ) \\ {s}_{x}^{′} = \{ index ( z ) \text{:} z ∈ {S}_{x} \}\end{matrix} \\ = {\prod }_{z ∈ {S}_{x}} {( {e ( g , g )}^{r \cdot {q}_{z} ( 0 )} )}^{{Δ}_{i , {s}_{x}^{′}} ( 0 )} \\ = {\prod }_{z ∈ {S}_{x}} {( {e ( g , g )}^{r \cdot {q}_{parent ( z )} ( index ( z ) )} )}^{{Δ}_{i , {s}_{x}^{′}} ( 0 )} ( by construction ) \\ = {\prod }_{z ∈ {S}_{x}} {e ( g , g )}^{r \cdot {q}_{x} ( i ) \cdot {Δ}_{i , {s}_{x}^{′}} ( 0 )} \\ = {e ( g , g )}^{r \cdot {q}_{x} ( 0 )} ( using polynomial interpolation )\end{matrix}$$

and returns the result.

Having thus defines the function DecryptNode, the decryption method executed by the method 1100 can be defined. The method 1100 begins by simply calling the function on the root node r of the access tree τ. If the access tree is satisfied by S, A=DecryptNode(CT,SK,R)=e(g,g)^{rq}^{ᵣ}^{⁽⁰⁾}=e(g,g)^{rs}. The method 1100 now decrypts by computing

\tilde{C}/(e(C,D)/A)=\tilde{C}(e(h^{s},g^{(a+r)/β})/e(g,g)^{rs})=M

The method 1100 outputs the message M in step 1108 before terminating in step 1110.

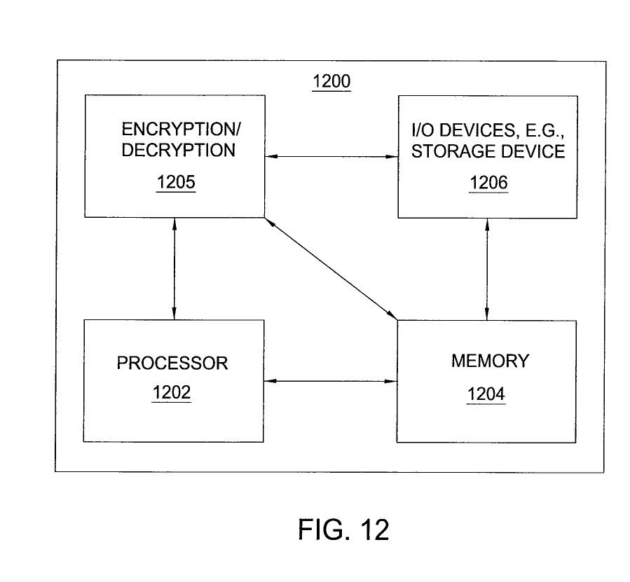

FIG. 12 is a high level block diagram of the encryption/decryption method that is implemented using a general purpose computing device 1200. In one embodiment, a general purpose computing device 1200 comprises a processor 1202, a memory 1204, an encryption/decryption module 1205 and various input/output (I/O) devices 1206 such as a display, a keyboard, a mouse, a modem, a network connection and the like. In one embodiment, at least one I/O device is a storage device (e.g., a disk drive, an optical disk drive, a floppy disk drive). It should be understood that the encryption/decryption module 1205 can be implemented as a physical device or subsystem that is coupled to a processor through a communication channel.

Alternatively, the encryption/decryption module 1205 can be represented by one or more software applications (or even a combination of software and hardware, e.g., using Application Specific Integrated Circuits (ASIC)), where the software is loaded from a storage medium (e.g., I/O devices 906) and operated by the processor 1202 in the memory 1204 of the general purpose computing device 1200. Additionally, the software may run in a distributed or partitioned fashion on two or more computing devices similar to the general purpose computing device 1200. Thus, in one embodiment, the encryption/decryption module 1205 for encrypting and decrypting data described herein with reference to the preceding figures can be stored on a computer readable medium or carrier (e.g., RAM, magnetic or optical drive or diskette, and the like).

It should be noted that although not explicitly specified, one or more steps of the methods described herein may include a storing, displaying and/or outputting step as required for a particular application. In other words, any data, records, fields, and/or intermediate results discussed in the methods can be stored, displayed, and/or outputted to another device as required for a particular application. Furthermore, steps or blocks in the accompanying Figures that recite a determining operation or involve a decision, do not necessarily require that both branches of the determining operation be practiced. In other words, one of the branches of the determining operation can be deemed as an optional step. Moreover, although steps of the methods described above may be illustrated in a certain sequence, those skilled in the art will appreciate that the steps of the methods described need not necessarily occur in the order illustrated. Thus, the accompanying Figures do not illustrate a mandatory sequential order.

Although various embodiments which incorporate the teachings of the present invention have been shown and described in detail herein, those skilled in the art can readily devise many other varied embodiments that still incorporate these teachings.

What is claimed is:

1. A method for encrypting data, the method comprising:
encrypting the data as a ciphertext;
labeling the ciphertext with a set of one or more descriptive attributes;
generating a first decryption key for decrypting the ciphertext;
associating an access structure with the first decryption key, such that the data is recoverable from the ciphertext using the first decryption key only if the set of one or more descriptive attributes satisfies the access structure; and
outputting the ciphertext and the first decryption key.

2. The method of claim 1, wherein the access structure comprises a tree, the tree comprising:
a plurality of leaf nodes, each of the plurality of leaf nodes being associated with one of the one or more descriptive attributes; and
a plurality of non-leaf nodes, each of the plurality of non-leaf nodes comprising a threshold gate.

3. The method of claim 2, wherein a threshold value of each of the plurality of non-leaf nodes is a positive number that is less than or equal to a number of child nodes associated with the each of the plurality of non-leaf nodes.

4. The method of claim 2, wherein generating a first decryption key comprises:
choosing, for each of the plurality of leaf nodes and each of the plurality of non-leaf nodes, a polynomial, wherein the choosing is performed in a top-down manner beginning with a root node of the access tree; and
generating, for each of the plurality of leaf nodes, a secret value, the secret value being computed in accordance with the polynomial.

5. The method of claim 4, wherein, for a given one of the plurality of leaf nodes and the plurality of non-leaf nodes, the polynomial is chosen such that a degree of the polynomial is one less than a threshold value of the given one of the plurality of leaf nodes and the plurality of non-leaf nodes.

6. The method of claim 1, wherein the access structure is represented as a monotone span program.

7. The method of claim 1, further comprising:
generating a second decryption key from the first decryption key.

8. The method of claim 7, wherein generating a second decryption key comprises:
adding a new trivial gate to the access structure;
manipulating an existing gate in the access structure such that the access structure is rendered more restrictive; and
deriving the second decryption key from the access structure, as manipulated.

9. The method of claim 8, wherein the manipulating comprises changing a gate type of an element of the access structure.

10. The method of claim 7, wherein the second decryption key is more restrictive than the first decryption key.

11. A computer readable storage medium containing an executable program for encrypting data, where the program performs the steps of:
encrypting the data as a ciphertext;
labeling the ciphertext with a set of one or more descriptive attributes;
generating a decryption key for decrypting the ciphertext;
associating an access structure with the decryption key, such that the data is recoverable from the ciphertext using the decryption key only if the set of one or more descriptive attributes satisfies the access structure; and
outputting the ciphertext and the decryption key.

12. The computer readable storage medium of claim 11, wherein the access structure comprises a tree, the tree comprising:
a plurality of leaf nodes, each of the plurality of leaf nodes being associated with one of the one or more descriptive attributes; and
a plurality of non-leaf nodes, each of the plurality of non-leaf nodes comprising a threshold gate.

13. The computer readable storage medium of claim 12, wherein a threshold value of each of the plurality of non-leaf nodes is a positive number that is less than or equal to a number of child nodes associated with the each of the plurality of non-leaf nodes.

14. The computer readable storage medium of claim 12, wherein generating a first decryption key comprises:
choosing, for each of the plurality of leaf nodes and each of the plurality of non-leaf nodes, a polynomial, wherein the choosing is performed in a top-down manner beginning with a root node of the access tree; and
generating, for each of the plurality of leaf nodes, a secret value, the secret value being computed in accordance with the polynomial.

15. The computer readable storage medium of claim 14, wherein, for a given one of the plurality of leaf nodes and the plurality of non-leaf nodes, the polynomial is chosen such that a degree of the polynomial is one less than a threshold value of the given one of the plurality of leaf nodes and the plurality of non-leaf nodes.

16. The computer readable storage medium of claim 11, wherein the access structure is represented as a monotone span program.

17. The computer readable storage medium of claim 11, further comprising:
generating a second decryption key from the first decryption key.

18. The computer readable storage medium of claim 17, wherein generating a second decryption key comprises:
adding a new trivial gate to the access structure;
manipulating an existing gate in the access structure such that the access structure is rendered more restrictive; and
deriving the second decryption key from the access structure, as manipulated.

19. The computer readable storage medium of claim 18, wherein the manipulating comprises changing a gate type of an element of the access structure.

20. The computer readable storage medium of claim 17, wherein the second decryption key is more restrictive than the first decryption key.

21. A system for encrypting data, the system comprising:
means for encrypting the data as a ciphertext;
means for labeling the ciphertext with a set of one or more descriptive attributes;
means for generating a decryption key for decrypting the ciphertext;
means for associating an access structure with the decryption key, such that the data is recoverable from the ciphertext using the decryption key only if the set of one or more descriptive attributes satisfies the access structure; and
means for outputting the ciphertext and the decryption key.

22. A method for decrypting data, the method comprising:
receiving a ciphertext, the ciphertext comprising the data in encrypted form, the ciphertext being labeled with a set of one or more descriptive attributes;
receiving a decryption key;
evaluating an access structure associated with the decryption key, where the data is recoverable from the ciphertext using the decryption key only if the set of one or more descriptive attributes satisfies the access structure; and
outputting the data of the access structure is satisfied.

23. A computer readable storage medium containing an executable program for decrypting data, where the program performs the steps of:
receiving a ciphertext, the ciphertext comprising the data in encrypted form, the ciphertext being labeled with a set of one or more descriptive attributes;
receiving a decryption key;
evaluating an access structure associated with the decryption key, where the data is recoverable from the ciphertext using the decryption key only if the set of one or more descriptive attributes satisfies the access structure; and
outputting the data of the access structure is satisfied.

24. Apparatus for decrypting data, where the program performs the steps of:
means for receiving a ciphertext, the ciphertext comprising the data in encrypted form, the ciphertext being labeled with a set of one or more descriptive attributes;
means for receiving a decryption key;
means for evaluating an access structure associated with the decryption key, where the data is recoverable from the ciphertext using the decryption key only if the set of one or more descriptive attributes satisfies the access structure; and
means for outputting the data of the access structure is satisfied.

25. A method for encrypting data, the method comprising:
encrypting the data as a ciphertext;
generating a decryption key for decrypting the ciphertext, the decryption;
labeling the decryption key with a set of one or more descriptive attributes;
associating an access structure with the ciphertext, such that the data is recoverable from the ciphertext using the decryption key only if the set of one or more descriptive attributes satisfies the access structure; and
outputting the ciphertext and the decryption key.

26. A method for decrypting data, the method comprising:
receiving a ciphertext, the ciphertext comprising the data in encrypted form, the ciphertext being associated with an access structure;
receiving a decryption key, the decryption key being labeled with a set of one or more descriptive attributes;
evaluating the access structure associated with the ciphertext, where the data is recoverable from the ciphertext using the decryption key only if the set of one or more descriptive attributes satisfies the access structure; and
outputting the data of the access structure is satisfied.
